(19) United States
(12) Patent Application Publication
(10) Pub. No.: US 2017/0150832 A1
(43) Pub. Date: Jun. 1, 2017

(54) SYSTEM FOR MOUNTING ART WORK ON SOLID FORM THAT CAN BE ROLLED UP

(71) Applicant: Bin Lu, Saratoga, CA (US)

(72) Inventor: Bin Lu, Saratoga, CA (US)

(21) Appl. No.: 14/955,804

(22) Filed: Dec. 1, 2015

(51) Int. Cl. A47G 1/06; G09F 13/18

(52) U.S. Cl. CPC A47G 1/0622; G09F 13/18

(57) ABSTRACT

The system invention herein disclosed and claimed is for mounting art work on a semi-rigid medium that can be rolled up for transport, then unrolled and framed.

### TECHNICAL FIELD

This invention is associated with art work mounting fixtures.

### BACKGROUND OF THE INVENTION

Art work in the form of photographs and graphics printed on opaque paper or translucent film is typically framed and used as decorations or promotional items. Often the art work is sent as rolled up paper or film and is then mounted and framed at another location.

Such art work could be mounted at the point of production on a backing medium and framed, but transporting it would be costly and pose damage risk.

It would be useful if there was a backing medium that provides the solid feel of a rigid medium but could be rolled up to allow easy and safer transport.

### BRIEF SUMMARY OF THE INVENTION

The invention herein disclosed and claimed is a medium that can be rolled up for transport, and when unrolled, forms a solid-feeling medium suitable for framing

The medium thus formed is a layered structure having a solid sheet on the front side, and a sheet on the back side made up of parallel strips of material that adjoin one another creating a solid surface when unrolled, but allows the medium to be rolled up for transport. An optional middle layer can be included which creates an air gap between the front and rear sheets using a flexible material that has been fan folded or corrugated. This intermediary layer gives the unrolled structure a greater thickness while still allowing the composite-layer structure to be rolled up for transport.

In addition to the medium, the system includes horizontal, vertical and medial support structures that create a frame for the unrolled medium and its mounted art work.

### BRIEF DESCRIPTIONS OF THE DRAWINGS

FIG. 1 depicts the rear sheet and front sheet plus bottom and side edge views.

FIG. 2 depicts the layered structure comprising the solid front sheet, the rear sheet with its adjoining strips, and a fan folded intermediary layer. The figure also shows how the composite structure can be rolled for transport or unrolled to form a flat medium surface.

FIG. 3 shows an example of art work mounted to the solid sheet of the medium when it is unrolled.

FIG. 4 illustrates how the unrolled medium can be framed using horizontal, vertical and medial support structures.

FIG. 5 shows edge, top, bottom and side views of the horizontal support structure.

FIG. 6 shows edge, top, bottom and side views of the vertical support structure.

FIG. 7 shows edge, top and side views of the medial support structure.

FIG. 8 shows the framed medium with art work mounted on it.

FIG. 9 shows another embodiment where one of the horizontal support structures has a series of light sources operative to source light into the intermediary layer, where the composite materials are translucent.

FIG. 10 shows the mounted and framed art work with the light-sourcing horizontal support structure at the top.

FIG. 11 shows the edge, top, bottom and side views of the light-sourcing horizontal support structure.

### DETAILED DESCRIPTION OF THE INVENTION

Art work on paper or film is often mounted on backing and framed for use as decoration or promotion. If mounted and framed at the location where the art work is produced, then transportation costs and risks of damage may be high. If the art work is rolled up, transported, then mounted and framed, transportation costs and damage risks may be lower but additional time and costs are incurred at the receiving end.

The invention herein disclosed and claimed is a medium designed to allow art work to be mounted onto a rigid surface that can also be rolled up for lower cost and lower risk transport. When it arrives at its destination, the mounted art work can be unrolled and in so doing forms a rigid composite structure ready for framing.

The medium is implemented by having a solid sheet of material, a front sheet, and a rear sheet of material created by side-by-side strips of material which form a solid surface when flat but allow the surface to expand when rolled up.

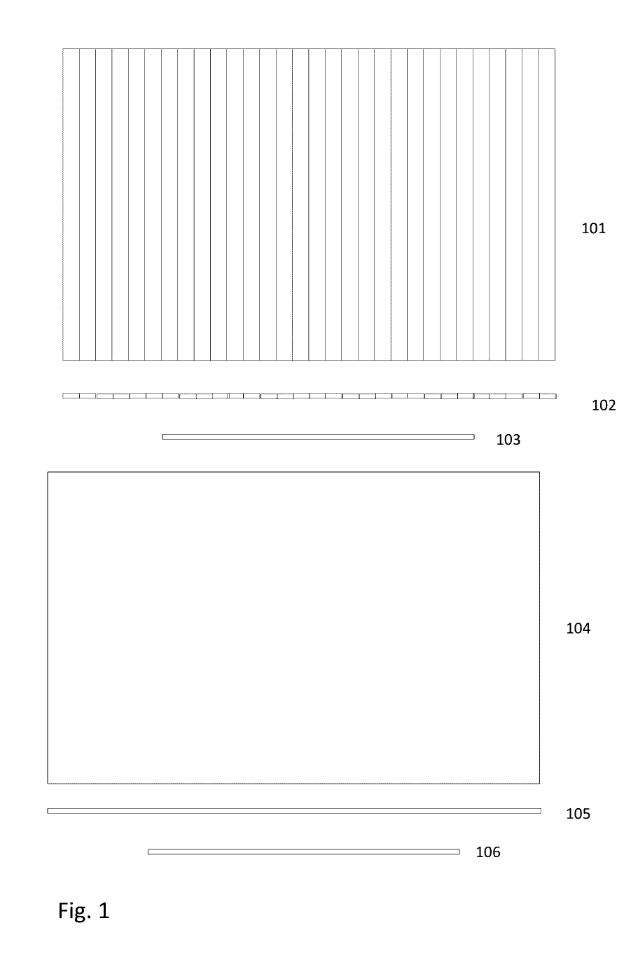

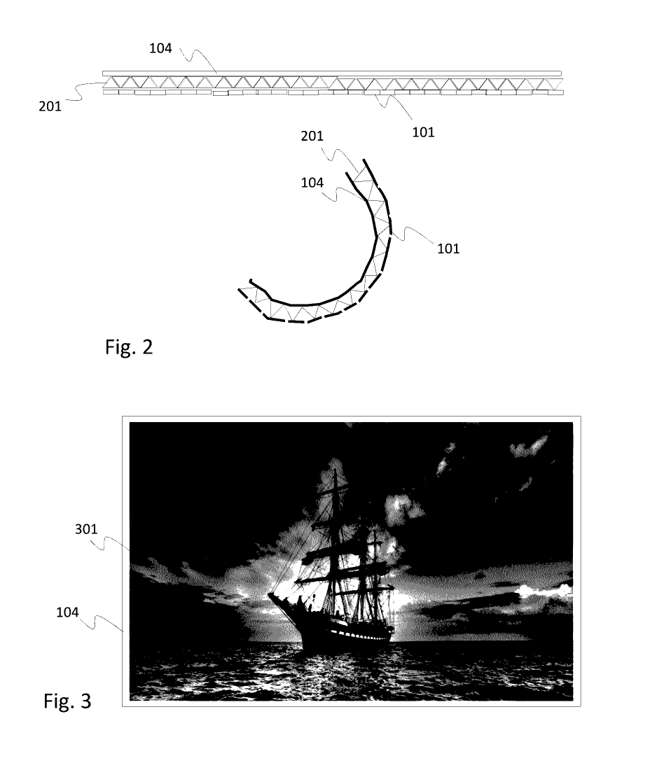

In FIG. 1, the rear sheet made up of individual, side-by-side strips is shown in a front view (101), bottom edge view (102) and side edge view (103). The front sheet made of a solid essentially rectangular sheet of semi-rigid material is shown in front view (104), bottom edge view (105) and side edge view (106). If front sheet and rear sheet were made to adhere to one another, the resulting medium would have twice the thickness and rigidity of either sheet but be capable of being rolled up for transport.

A thicker medium could be implemented by having an intermediary sheet of material (201) sandwiched between the front sheet (104) and rear sheet (101). The intermediary sheet could be fan folded as shown or corrugated (not shown) to create an air gap between the front and rear sheets for greater thickness. As shown, because of the structure of the rear sheet and intermediary sheet, the composite structure formed by the three sheets of material will allow it to be rolled up.

When the composite medium is unrolled, it will form a rigid structure essentially equivalent to having two front sheets glued together to be double thickness. If an intermediary sheet is employed, the unrolled medium has the added thickness due to the air gap. The thickness of that air gap is determined by the dimensions of the fan fold or corrugation dimensions. Prior to rolling up the medium, while it is planar and rigid, an art work (301) can be mounted to the front sheet (104) as shown in FIG. 3.

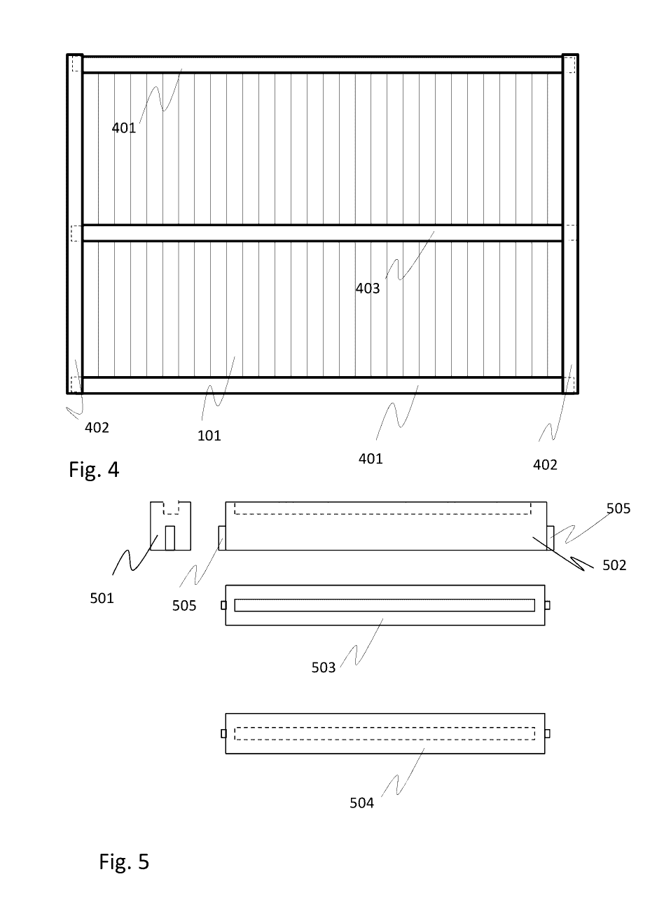

When the medium with mounted art work is unrolled, it can be framed using a set of horizontal, vertical and medial support structures. The assembled frame is shown in FIG. 4 with horizontal support structures (401), vertical support structures (402) and medial support structure (403).

FIG. 5 shows edge (501), side (502), top (503) and bottom (504) views of the horizontal support structure. The horizontal support structure has a groove along its length, located essentially equidistant from its sides into which the edge of the composite medium and mounted art work will extend. That will maintain the unrolled orientation. On the edges of the horizontal support structure are two appendages (505). These are operative to extend into mating structures of the vertical support structures.

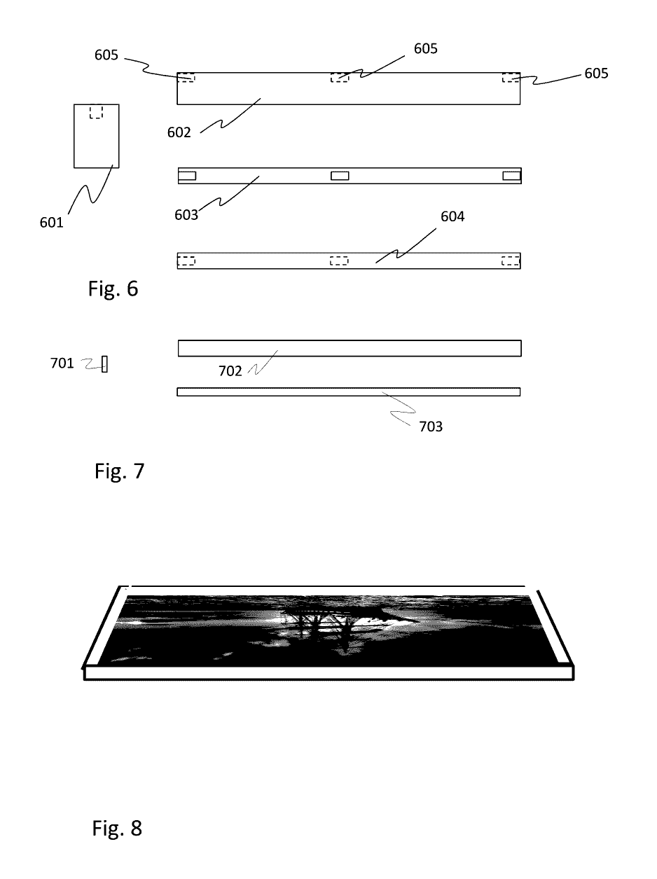

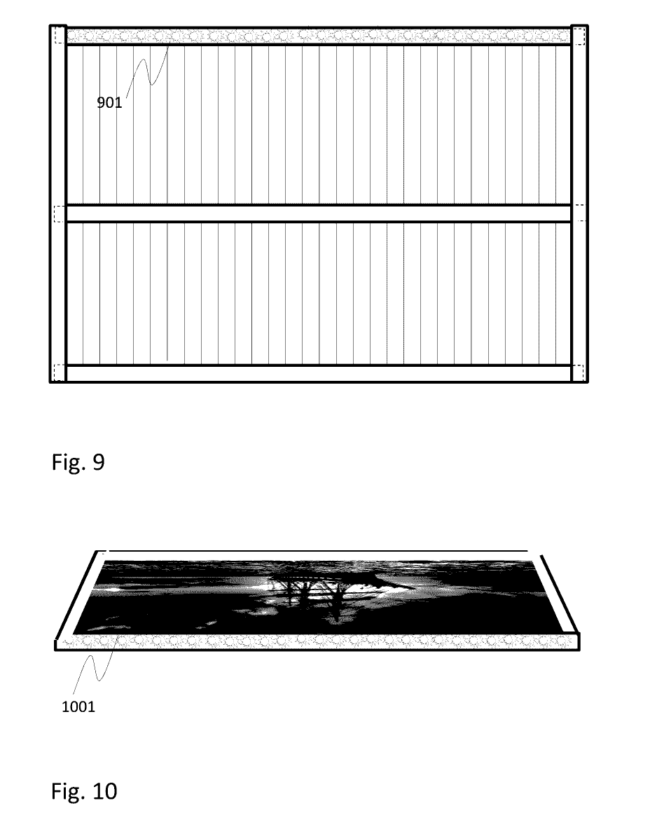

FIG. 6 shows the edge (601), side (602), top (603) and bottom (604) views of the vertical support structure. As shown, it has three mating structure cavities (605) into which the appendages on the horizontal support structures and the edges of the medial support structure will extend.

FIG. 7 shows the edge (701), side (702), and top/bottom (703) views of the medial support structure. The arrangement and interfacing of the horizontal, vertical and medial support structures are as shown in FIG. 4.

FIG. 8 shows a view from top edge, down, of the framed medium with mounted art work.

In another embodiment of the system, one horizontal support structure is equipped with a string of light sources (901) operative to source light into the edge of the intermediary sheet. Where the front and intermediary sheets are made of translucent material, and the art work film is translucent, the light source will illuminate the art work.

FIG. 10 shows a top edge view, down, with the light-source horizontal support structure in position on the framed medium with mounted art work.

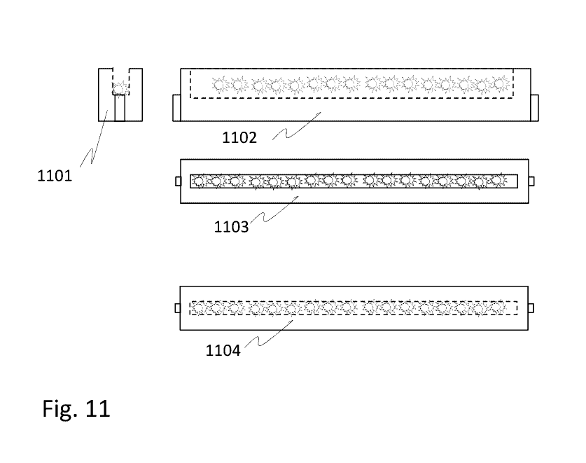

FIG. 11 shows the edge (1101), side (1102), bottom (1103) and top (1104) views of the light-source horizontal support structure. It, too, has appendages on the edges which mate with the mating structure cavities of the vertical support structures.

Note that the materials used for the front, rear and intermediary sheets can be opaque or translucent. The materials used for the horizontal, vertical and medial support structures can be any material sufficiently rigid, such as wood, hard plastic, metal and the like. The light source for the horizontal support structure embodiment can be any technology that produces sufficient illumination and meets the heat and power consumption requirements, such as LED light sources.

What is claimed is:

1. A system comprising:
A front sheet comprising a solid sheet of essentially rectangular bendable material;
An intermediary sheet of flexible material fan folded or corrugated;
A back sheet comprising separate strips of rectangular bendable material, said separate strips arrayed parallel to one another, in a plane, where adjacent sides of said separate strips adjoin one another;
Said front sheet, said intermediary sheet, and said back sheet sandwiched together to form an essentially rectangular structure with a solid front face, a back face comprising said separate strips of rectangular bendable material, and an air gap between said front sheet and said back sheet whose thickness is determined by the dimensions of said fan folds or corrugations of said intermediary sheet;
Said front sheet, said intermediary sheet, and said back sheet are made to adhere so as to create a composite plywood-like structure exposing one face of said front sheet, one face of said back sheet; and composite edges comprising an edge of said front sheet, and edge of said back sheet, and an edge of said intermediary sheet in between.

2. A system as in claim 2 further comprising said front sheet, and said intermediary sheet comprising translucent material.

3. A system as in claim 1 further comprising:
A horizontal support structure whose thickness is greater than said composite edge thickness; and whose length is essentially equal to the length of said composite structure;
Said horizontal support structure comprising a groove extending from end to end into which said composite edge of said composite structure will extend;
Said horizontal support structure having an appendage on each end.

4. A system as in claim 3 further comprising:
A medial horizontal support structure whose thickness is essentially half that of said horizontal support structure and whose length is essentially equal to the length of said horizontal support structure plus the length of said appendage on each end.

5. A system as in claim 3 further comprising:
A vertical support structure whose thickness is essentially equal to said thickness of said horizontal support structure;
Said vertical support structure having mating structure cavities at each end essentially equal to the dimensions of said appendages such that said appendage will fit snugly into said end cavities;
Said vertical support structure having a medial mating structure cavity, half way between said ends, of essentially the same width and height of said medial support structure such that the ends of said medial support structure will fit snugly into said medial cavity of said vertical support structure.

6. A system as in claim 3 further comprising:
A series of small light sources extending along said groove of said horizontal support structure and operative to source light into said composite edge of said composite structure.
